(19) United States
(12) Patent Application Publication
(10) Pub. No.: US 2026/0239272 A1
(43) Pub. Date: Aug. 13, 2026

(54) METHODS AND APPARATUS FOR DYNAMIC SL-PRS RESOURCE ALLOCATION SCHEME DETECTION

(71) Applicant: InterDigital Patent Holdings, Inc., Wilmington, DE (US)

(72) Inventors: Tao DENG, New York, NY (US); Fumihiro HASEGAWA, Westmount (CA); Tuong HOANG, Montreal (CA); Paul MARINIER, Brossard (CA); Moon IL LEE, Melville, NY (US); Kunjan SHAH, London (GB)

(73) Assignee: InterDigital Patent Holdings, Inc., Wilmington, DE (US)

(21) Appl. No.: 19/153,514

(22) PCT Filed: Feb. 12, 2024
(86) PCT No.: PCT/US2024/015382

§ 371 Date: Aug. 4, 2025

Related U.S. Application Data
(60) Provisional application No. 63/445,462, filed on Feb. 14, 2023.

(51) Int. Cl. H04W 64/00; H04W 72/25

(52) U.S. Cl. CPC H04W 64/00; H04W 72/25

(57) ABSTRACT

A method performed by a first wireless transmit/receive unit (WTRU) may comprise: receiving configuration information, the configuration information including a set of resource selection methods for a sidelink-position reference signal (SL-PRS) transmission; determining a resource selection method for a SL-PRS transmission, the determination being based on a condition, wherein the resource selection method includes at least one of a full sensing, partial sensing, and random selection; and transmitting, to a second WTRU, information indicating the selected method of SL-PRS transmission.

### CROSS-REFERENCE TO RELATED APPLICATIONS

This application claims the benefit of U.S. Provisional Application No. 63/445,462, filed Feb. 14, 2023, the contents of which are incorporated herein by reference.

### BACKGROUND

Sidelink (SL) positioning has been studied in RAN1 for SL-only-base positioning and a combination of SL- and Uu-based positioning. SL positioning methods including SL-Round Trip Time (RTT), SL-Angle of Arrival (AoA) and SL-Time Difference of Arrival (TDoA) are supported for SL positioning. For SL-TDoA, solutions based on both DL-TDoA and UL TDoA are considered.

A “timing/angle positioning method” may refer to any positioning method that uses reference signals such as SL-PRS. The WTRU receives multiple reference signals from WTRU(s) and measures RSTD, RSRP, and/or AoA. Examples of angle/timing positioning methods are SL-AoD or SL-TDOA positioning. In another example, the WTRU may transmit a SL-PRS to WTRU(s) and receiver performs measurements (e.g., RSTD, AoA, RSRP) for determination of the locations of the WTRU which transmitted SL-PRS.

A “RTT positioning method” may refer to any positioning method that requires two WTRUs to transmit SL-PRS to each other. In one example, an anchor WTRU may transmit a SL-PRS to the target WTRU. Once the target WTRU receives the SL-PRS from the anchor WTRU, the target WTRU may transmit a SL-PRS to the anchor WTRU. The target WTRU may measure WTRU Tx-Rx time difference which is the difference between transmission time of SL PRS from the target WTRU and reception time of SL-PRS transmitted from the anchor WTRU. The target WTRU may report the WTRU Tx-Rx time difference to the anchor WTRU/network (e.g., gNB, LMF).

As used hereinafter, the term “network” may include AMF, LMF, gNB or NG-RAN. “Pre-configuration” and “configuration” may be used interchangeably in this disclosure. The terms “non-serving gNB” and “neighboring gNB” may be used interchangeably. The terms “gNB” and “TRP” may be used interchangeably. The terms “PRS” and “PRS resource” may be used interchangeably. The terms “PRS(s)” or “PRS resource(s)” may be used interchangeably. The “PRS(s)” or “PRS resource(s)” may belong to different PRS resource sets. The terms “PRS” or “DL-PRS” or “DL PRS” may be used interchangeably. The terms “Measurement gap” or “Measurement gap pattern” may be used interchangeably in this disclosure. “Measurement gap pattern” may include parameters such as measurement gap duration or measurement gap repetition period or measurement gap periodicity.

A PRU may be a WTRU or TRP whose location (e.g., altitude, latitude, geographic coordinate, or local coordinate) is known by the network (e.g., gNB, LMF). Capabilities of PRU may be the same as a WTRU or TRP (e.g., capable of receiving PRS or transmit SRS or SRS for positioning, return measurements, or transmit PRS). The WTRUs acting as PRUs may be used by the network for calibration purposes (e.g., correct unknown timing offset, correct unknown angle offset). An LMF is a non-limiting example of a node or entity (e.g., network node or entity) that may be used for or to support positioning. Any other node or entity may be substituted for LMF and still be consistent with this disclosure.

A SL-PRS transmission may use a comb pattern and a pseudorandom-based sequence and may be based on two resource allocation schemes, Scheme 1 and Scheme 2. In Scheme 1, SL-PRS resource allocation is performed by the NW. In Scheme 2, a WTRU may perform autonomous SL-PRS resource allocation based on legacy SL Mode 2 resource selection (i.e. SL sensing).

In one example, a SL-PRS configuration may contain at least one of the following parameters: number of symbols, transmission power, number of SL-PRS resources included in SL-PRS resource set, muting pattern for SL-PRS (for example, the muting pattern may be expressed via a bitmap), periodicity, type of SL-PRS (e.g., periodic, semi-persistent, or aperiodic), slot offset for periodic transmission for SL-PRS, vertical shift of SL-PRS pattern in the frequency domain, time gap during repetition, repetition factor, RE (resource element) offset, comb pattern, comb size, spatial relation, QCL information (e.g., QCL target, QCL source) for SL-PRS, number of PRUs, number of TRPs, Absolute Radio-Frequency Channel Number (ARFCN), subcarrier spacing, expected RSTD, uncertainty in expected RSTD, start Physical Resource Block (PRB), bandwidth, BWP ID, number of frequency layers, start/end time for PRS transmission, on/off indicator for SL-PRS, TRP ID, SL-PRS ID, cell ID, global cell ID, PRU ID, and applicable time window. The WTRU may apply a SL-PRS configuration under a condition that the current time is within an applicable time window.

### SUMMARY

A method performed by a first wireless transmit/receive unit (WTRU) may comprise: receiving configuration information, the configuration information including a set of resource selection methods for a sidelink-position reference signal (SL-PRS) transmission; determining a resource selection method for a SL-PRS transmission, the determination being based on a condition, wherein the resource selection method includes at least one of a full sensing, partial sensing, and random selection; and transmitting, to a second WTRU, information indicating the selected method of SL-PRS transmission. The condition may be based on a sidelink-channel busy ratio (SL-CBR) measurement, a quality of service (QOS) level indication of the SL-PRS transmission, a channel condition, an inter-WTRU coordination information, and/or a SL-PRS transmission feedback. The information indicating the selected method of SL-PRS transmission may be transmitted in a sidelink control information (SCI) with the SL-PRS transmission.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment; and

FIG. 2 is an example of a procedure for a dynamic determination of a resource selection scheme.

### DETAILED DESCRIPTION

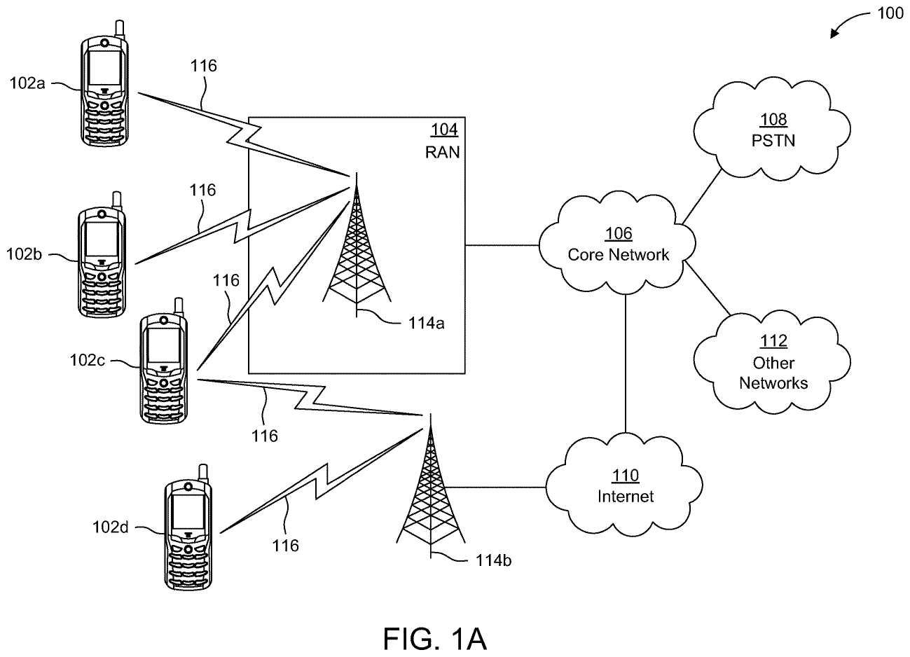

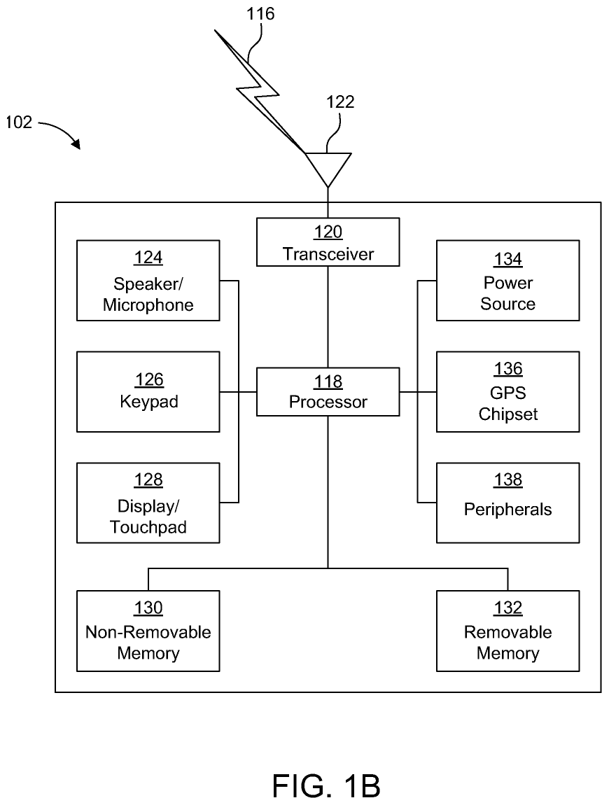

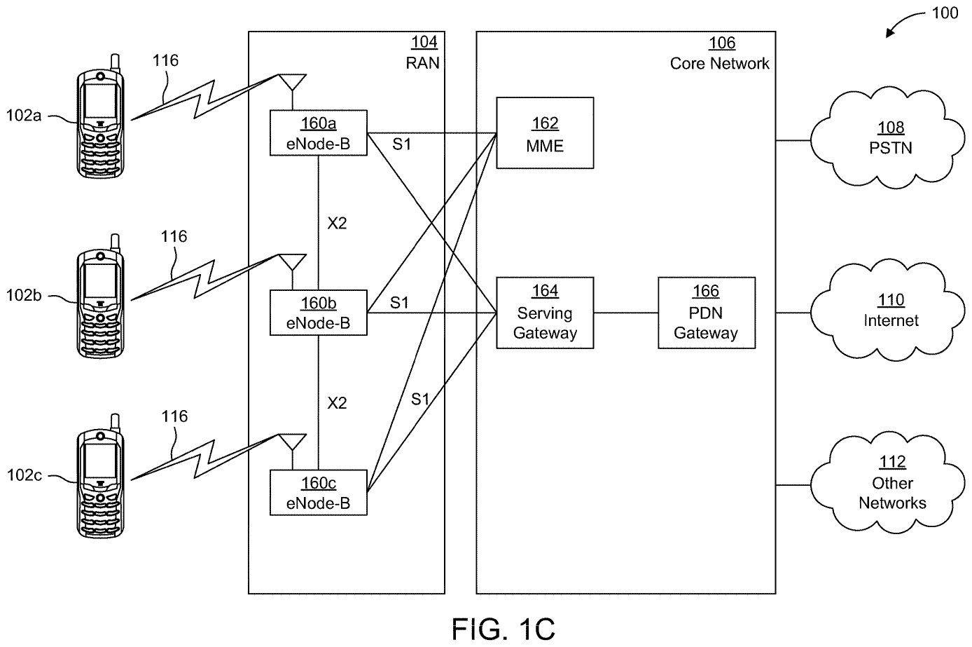

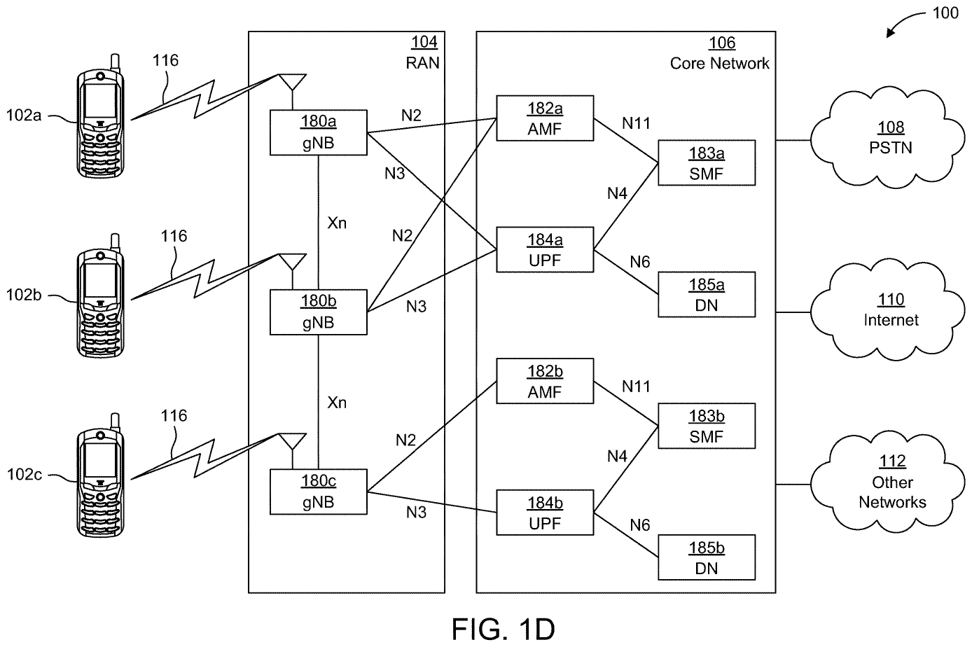

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (STA), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using NR.

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VoIP) services to one or more of the WTRUs 102a, 102b, 102c, 102d. The data may have varying quality of service (QOS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or WiFi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz, and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode) transmitting to the AP, all available frequency bands may be considered busy even though a majority of the available frequency bands remains idle.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 104 and the CN 106 according to an embodiment. As noted above, the RAN 104 may employ an NR radio technology to communicate with the WTRUs 102a, 102b, 102c over the air interface 116. The RAN 104 may also be in communication with the CN 106.

The RAN 104 may include gNBs 180a, 180b, 180c, though it will be appreciated that the RAN 104 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, DC, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 106 shown in FIG. 1D may include at least one AMF 182a, 182b, at least one UPF 184a, 184b, at least one Session Management Function (SMF) 183a, 183b, and possibly a Data Network (DN) 185a, 185b. While the foregoing elements are depicted as part of the CN 106, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and the like. The AMF 182a, 182b may provide a control plane function for switching between the RAN 104 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 106 via an N11 interface. The SMF 183a, 183b may also be connected to a UPF 184a, 184b in the CN 106 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 104 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering DL packets, providing mobility anchoring, and the like.

The CN 106 may facilitate communications with other networks. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Acronyms and abbreviations as used in the preceding and following paragraphs may be defined as follows:
ACK Acknowledgement
AoA Angle of Arrival
AoD Angle of Departure
ARFCN Absolute Radio-Frequency Channel Number
BLER Block Error Rate
BW Bandwidth
BWP Bandwidth Part
CAP Channel Access Priority
CAPC Channel access priority class
CBR Channel Busy Ratio
CCA Clear Channel Assessment
CCE Control Channel Element
CE Control Element
CG Configured Grant or Cell Group
CORESET Control Resource Set
CP Cyclic Prefix
CP-OFDM Conventional OFDM (relying on cyclic prefix)
CQI Channel Quality Indicator
CRC Cyclic Redundancy Check
CSI Channel State Information
CW Contention Window
CWS Contention Window Size
CO Channel Occupancy
DAI Downlink Assignment Index
DCI Downlink Control Information
DFI Downlink feedback information
DG Dynamic grant
DL Downlink
DM-RS Demodulation Reference Signal
DRB Data Radio Bearer
DRX Discontinuous Reception
ECID Enhanced Cell ID
eLAA enhanced Licensed Assisted Access
eMBB enhanced Mobile Broadband
FeLAA Further enhanced Licensed Assisted Access
HARQ Hybrid Automatic Repeat Request
IM Interference Measurement
LAA License Assisted Access
LBT Listen Before Talk
LCH Logical Channel
LCP Logical Channel Priority
LBT Listen-Before-Talk
LOS Line of Sight
NLOS Non Lie of Sight
LMF Location Management Function
LPP LTE Positioning Protocol
LTE Long Term Evolution e.g. from 3GPP LTE R8 and up
MAC CE MAC Control Element
MAC Medium Access Control
MCS Modulation and Coding Scheme
MIMO Multiple Input Multiple Output
NACK Negative ACK
NAS Non-access stratum
NR New Radio
OFDM Orthogonal Frequency-Division Multiplexing
OTDOA Observed Time Difference of Arrival
PDCCH Physical Downlink Control Channel
PDSCH Physical Downlink Shared Channel
PDU Packet Data Unit
PHY Physical Layer
PID Process ID
PO Paging Occasion
PRACH Physical Random Access Channel
PRS Positioning Reference Signal
PRU Positioning Reference Unit
PSFCH Physical Sidelink Feedback Channel
PSS Primary Synchronization Signal
PTRS Phase Tracking Reference Signal
PUCCH Physical Uplink Control Channel
PUSCH Physical Uplink Shared Channel
RA Random Access (or procedure)
RACH Random Access Channel
RAR Random Access Response
RCU Radio access network Central Unit
RE Resource Element
RF Radio Front end
RLF Radio Link Failure
RLM Radio Link Monitoring
RNTI Radio Network Identifier
RNA RAN Notification Area
RO RACH occasion
RRC Radio Resource Control
RRM Radio Resource Management
RTT Round Trip Time
RP Reception Point
RS Reference Signal
RSRP Reference Signal Received Power
RSTD Reference Signal Time Difference
RTT Round Trip Time
RSSI Received Signal Strength Indicator
RTOA Relative Time of Arrival
SDAP Service data adaptation protocol
SDU Service Data Unit
SRB Signaling Radio Bearer
SRS Sounding Reference Signal
SS Synchronization Signal
SSS Secondary Synchronization Signal
SWG Switching Gap (in a self-contained subframe)
SPS Semi-persistent scheduling
SUL Supplemental Uplink
TB Transport Block
TBS Transport Block Size
TDoA Time Difference of Arrival
TRP Transmission-Reception Point
TSC Time-sensitive communications
TSN Time-sensitive networking
TTI Transmission Time Interval
UCI Uplink Control Information
UL Uplink
URLLC Ultra-Reliable and Low Latency Communications
WBWP Wide Bandwidth Part
WLAN Wireless Local Area Networks and related technologies (IEEE 802.xx domain)

In Mode 2, SL sensing is applied for SL PSSCH/PSCCH resource selection and includes full sensing, partial sensing and random selection. In full sensing, a WTRU evaluate all candidate resources within a resource selection window (RSW) to select available candidate resources. In partial sensing, a WTRU may perform periodical-based partial sensing (PBPS) and contiguous partial sensing (CPS) and only a portion of candidate resources are evaluated for availability. Parameters related to partial sensing (e.g., sensing occasion periodicity and number of CPS sensing slots) are indicated by higher layers. In random selection, a WTRU may not evaluate the availability of any candidate resource within a RSW and randomly select SL transmission resources. Partial sensing and random selection are intended for WTRU power saving purpose and therefore, may be referred to as power saving sensing.

With full sensing, due to hidden node and the sensing mechanism of incrementing RSRP to achieve desired number of resources, a SL transmission in the selected resources may collide with another SL transmission, especially in a congested condition. For power saving sensing, the reduced number of candidate resources for evaluation in partial sensing and performing no evaluation in random selection provides significant power saving but degrades the reliability of the SL transmission due to significantly increased probability of SL transmission collisions in the selected resources.

A SL-PRS Scheme 2 resource selection based on the SL Mode 2 legacy sensing may inherit the problem of SL collisions in the selected resources. The problem is exacerbated when using power saving sensing and/or selecting a SL-PRS resource with a large bandwidth. To achieve high SL positioning accuracy, a robust SL-PRS transmission is necessary and thus mechanisms are desirable to minimize collisions between SL-PRS transmissions or between SL-PRS transmission and SL data transmission and enhance the reliability of the SL-PRS transmissions based on Scheme 2 sensing.

A SL-PRS transmission may experience “near-far” interference when RE-level orthogonal multiplexing is applied between SL-PRS transmissions from different WTRUs. A similar situation in Uu positioning is handled with gNB muting in which a nearby gNB configures with muting of certain DL-PRS resources (i.e., no DL-PRS transmissions at muted DL-PRS resources to allow a WTRU to receive DL-PRS transmissions from another distant gNB). Without such a muting, a WTRU may not able to receive a weak DL-PRS transmission from the distant gNB due to the limited receiver dynamic range, even when the DL-PRS transmission from the nearby gNB are orthogonal at RE level. This type of interference may become more dynamic for SL-PRS transmission due to the WTRU mobility and thus mechanisms are desired to address this problem.

In another embodiment, a WTRU may be (pre)configured with a set of resource allocation schemes to use for resource (re)selection of SL-PRS transmissions. The set or resource allocation schemes may include full sensing, partial sensing, and/or random selection. When partial sensing is selected, a WTRU may evaluate the availability of a sub-set of candidate resource in a resource selection window. The number of the resources in the sub-set may be (pre)configured by higher layers. When random selection is selected, a WTRU may randomly select a candidate resource in a RSW for SL transmission without evaluating its availability. Random selection and partial sensing may significantly reduce the WTRU processing and battery consumption at the expense of SL-PRS transmission reliability.

In one embodiment, a WTRU in Scheme 2 resource allocation may determine to select one (pre)configured resource allocation scheme based on one or more of the following conditions: (1) L2 source and/or destination ID of SL-PRS transmission; (2) QoS level of the SL-PRS transmission; (3) SL CBR measurement of the resource pool; (4) SL measurement reported by peer WTRUs in a SL positioning group; (5) own sensing result; (6) received preferred resource set; (7) received non-preferred resource set; (8) received conflict indication in PSFCH; (9) receive muting indication; (10) SL-PRS transmission feedback; (11) cast type of SL-PRS transmission; (12) power saving state; and/or (13) WTRU hardware capability.

With respect to the L2 source and/or destination ID of a SL-PRS transmission, a WTRU may be (pre)configured with a L2 source and/or destination ID of SL-PRS transmissions for a SL position session. The L2 IDs may be associated with a SL positioning method, (e.g., SL-AoA, SL-TDoA or RTT) used in the SL positioning session and a WTRU may be (pre)configured with a resource allocation scheme for a L2 ID. A WTRU may thus determine a resource allocation scheme according to L2 source and/or destination ID of the SL-PRS transmission.

The QoS level of the SL-PRS transmission, may, for example, be based on required positioning accuracy, latency, priority, etc. In one example, a WTRU may be (pre)configured with one or more QoS levels (e.g. priority levels) associated with each resource selection scheme. A WTRU may determine a resource selection scheme based on the (pre)configured association. In another example, a WTRU may be (pre)configured with one or more QoS level (e.g., priority level) thresholds. A WTRU may determine to select full sensing when the QoS level (e.g., priority level) of a SL-PRS transmission is higher than a (pre)configured threshold.

With respect to the SL CBR measurement of the resource pool, in one example, a WTRU may be (pre)configured with one or more CBR threshold associated with each resource allocation scheme. A WTRU may determine to select full sensing when a measured SL CBR value exceeds a (pre)configured threshold associated with full sensing scheme. In another example, a WTRU may determine to select random selection when a measured SL CBR value is below a (pre)configured threshold associated with random selection scheme.

SL measurement reported by peer WTRUs in a SL positioning group may include SL RSRP, SL CQI, SL RSSI and other SL measurements from peer WTRUs in the SL positioning group. In one example, a WTRU may determine to select full sensing when the measured SL RSRP and/or SL CQI is below a (pre)configured threshold. In another example, a WTRU may determine to select full sensing when the measured SL RSSI exceeds a (pre)configured threshold.

A WTRU may determine a resource selection scheme based on its own full and/or partial sensing results, for example, the number of RSRP increments performed during the sensing and the average RSSI of the selected resources. A large number of RSRP increments and/or high average RSSI of the selected resources may indicate a high interference and/or congestion level in the channel. A WTRU may determine to select full sensing when one or more of sensing results are higher than (pre)configured threshold.

The IUC information may be a preferred resource set including resources preferred by a peer WTRU to receive SL-PRS transmission from the WTRU receiving the IUC information. A WTRU may determine to select partial sensing and/or full sensing when the ratio of the number of received preferred resources to the number of total candidate resources in the RSW for a SL-PRS transmission is below a (pre)configured threshold. A WTRU may determine an available candidate resource set as a union of the received preferred resources and the available resources from its own sensing result. A WTRU may determine to select random selection within the received preferred resource set when the ratio of the number of received preferred resources to the number of total candidate resources in the RSW for a SL-PRS transmission exceeds a (pre)configured threshold.

A WTRU may receive Inter WTRU Coordination (IUC) information of a non-prefer resource set from a peer WTRU in a SL positioning group. A WTRU may determine not to use these received non-prefer resources for SL-PRS transmission. A WTRU may determine to select full sensing when the ratio of the number of received non-preferred resources to the number of total candidate resources in the RSW for a SL-PRS transmission exceeds a (pre)configured threshold.

A WTRU may receive a conflict indication in a PSFCH that indicates a conflict between the WTRU's resource reservation for a SL-PRS transmission and another WTRU's resource reservation for a SL transmission, i.e., the reserved resources may overlap fully or partially. A WTRU may determine to select full sensing for SL-PRS resource (re)selection when a WTRU receives a conflict indication in PSFCH.

A WTRU may receive a muting indication in a broadcast transmission and/or PSFCH that indicates muted resources. A WTRU may determine to select full sensing for SL-PRS resource (re)selection when a WTRU receives a muting indication.

A WTRU may receive a feedback associated with a performed SL-PRS transmission. A WTRU may determine to select full sensing for SL-PRS resource (re)selection for a SL-PRS re-transmission when a WTRU receives a SL-PRS transmission feedback indicating a request for SL-PRS re-transmission and/or a measured SL-PRS transmission RSRP below a (pre)configured threshold.

A WTRU may apply different sets of conditions to determine a resource allocation scheme for a cast type of SL-PRS transmission. For example, for a broadcast SL-PRS transmission applied for anchor WTRU discovery, a WTRU may determine a resource allocation scheme based on CBR and/or SL measurement threshold higher than that used for a unicast SL-PPRS transmission used for SL positioning measurement (e.g., RTT-based).

A WTRU may determine to apply random selection for SL-PRS transmission when a WTRU enters a power saving state, (e.g., IDLE or INACTIVE state).

A WTRU may perform random selection for SL-PRS transmission when the WTRU is not equipped with a hardware receiver. For example, a Vulnerable Road User (VRU) broadcast device may be equipped with only a transmitter for broadcast transmission.

A WTRU may indicate the resource allocation scheme used for a SL-PRS transmission in the SCI carried in the SL-PRS transmission. In another example, a WTRU may indicate the resource allocation scheme to the peer WTRUs in a SL positioning group.

A WTRU may receive a SL-PRS transmission based on random selection from a peer WTRU in a SL positioning group. A WTRU may transmit a muting indication including a muting pattern based on the SL-PRS resource reservation indicated in the SCI of the SL-PRS transmission.

In another example, when receiving a SL-PRS transmission based on random selection, a WTRU may determine to transmit a muting indication based on one or more of the following:

When receiving a SL-PRS transmission based on random selection, a WTRU may determine to transmit a muting indication based on SL-PRS transmission QoS level indicated in the SCI. For example, a WTRU may determine to transmit a muting indication when the QoS level of the received SL PRS transmission based random selection exceeds a (pre)configured threshold.

When receiving a SL-PRS transmission based on random selection, a WTRU may determine to transmit a muting indication based on Detection of an interference. For example, a WTRU may determine to transmit a muting indication when one or more of the above discussed interference patterns is detected.

When receiving a SL-PRS transmission based on random selection, a WTRU may determine to transmit a muting indication based on SL CBR measurement of the resource pool. For example, a WTRU may determine to transmit a muting indication when the measured SL CBR of the resource pool used for the resource (re)selection exceeds a (pre)configured threshold.

When receiving a SL-PRS transmission based on random selection, a WTRU may determine to transmit a muting indication based on RSRP measurement of the received SL-PRS transmission. For example, a WTRU may determine to transmit a muting indication when the measured RSRP of the received SL-PRS transmission is below a (pre)configured threshold.

A WTRU may continue to receive SL-PRS transmissions based on random selection after transmission of muting indication. For example, a WTRU may transmit a resource re-selection indication to request a switch from random selection to full sensing.

A WTRU may receive a SL-PRS transmission resource reservation from a peer WTRU in a SL positioning group. In one example, an anchor WTRU may receive a resource reservation for a backward SL-PRS transmission in the forward SL-PRS transmission received from a target WTRU. In another example, an anchor WTRU may receive a resource reservation from a target WTRU to use for a SL-PRS transmission to the target WTRU for SL TDoA measurement. Herein, a WTRU that receives a SL-PRS transmission resource reservation may be referred to as a scheduled WTRU and the peer WTRU sending the resource reservation may be referred to as scheduling WTRU.

A scheduled WTRU may determine that the reserved SL-PRS transmission may be selected using random selection based on an indication in the SCI associated with a received SL-PRS transmission from the scheduling WTRU. In another example, a scheduled WTRU may receive a message from the scheduling WTRU including an indication of a resource selection scheme. A scheduling WTRU may determine to select random selection based on the conditions and/or measurements, which may not apply to a scheduled WTRU. Thus, a scheduled WTRU may determine to apply its own resource selection scheme to override the received resource reservation.

In one example, when receiving a resource reservation for a SL-PRS transmission based on random selection, a WTRU may determine to select a resource selection scheme based on the above-discussed conditions and criteria for the reserved SL-PRS transmission. If a WTRU selects full sensing and random selection is indicated, a WTRU may perform full sensing and perform a SL-PRS transmission in the resources based on its own sensing result.

In another embodiment, a WTRU may receive a (pre)configuration with a set of resources selection schemes, including, full sensing, partial sensing, and random selection. The WTRU may determine a resource selection scheme for SL-PRS transmissions based on: (1) SL CBR measurement; (2) QoS level indication of the SL-PRS transmission; (3) channel conditions; (4) received inter-WTRU coordination (IUC) information; and/or (5) received SL-PRS transmission feedback.

The WTRU may determine a resource selection scheme for SL-PRS transmissions based on SL CBR measurement. The WTRU may be configured with SL CBR thresholds associated to each resource selection scheme and determines a resource selection scheme based on measured SL CBR and the configuration.

The WTRU may determine a resource selection scheme for SL-PRS transmissions based on QoS level indication of the SL-PRS transmission. The QoS level indication of the SL-PRS transmission the WTRU may be configured with one or more priorities associated to each resource selection scheme and determines a resource selection scheme based on the priority of a SL-PRS transmission indicated by higher layers.

The WTRU may determine a resource selection scheme for SL-PRS transmissions based on channel conditions. For the channel conditions, the WTRU may be configured with one or more SL measurement(s) (e.g., RSRP and RSSI) thresholds and determines a resource selection scheme based on the SL measurements and configuration.

The WTRU may determine a resource selection scheme for SL-PRS transmissions based on received IUC information. The WTRU may receive a preferred and/or non-preferred resource set information for a SL-PRS transmission and determines a resource selection scheme based on, for example, the number of the resources included in the set.

The WTRU may determine a resource selection scheme for SL-PRS transmissions based on received SL-PRS transmission feedback. The WTRU may determine a resource selection scheme based on a feedback transmission associated with a SL-PRS transmission (e.g. a re-transmission request and/or a conflict indication).

In another embodiment, a WTRU may request other WTRUs to mute during its measurement gap (MG) and/or Positioning processing window (PPW) in Uu. Specifically, the WTRU may receive the configuration of MG/PPW in Uu. The WTRU may then indicate to the peer WTRU such configuration. The WTRU may implicit/explicitly request the peer WTRU not to perform sidelink transmission for itself in the (pre-)configured MG/PPW period. The peer WTRU may then mute its sidelink transmission to the WTRU during the (pre-)configured MG/PPW period.

The WTRU may transmit an indication of the selected resource selection scheme to peer WTRU(s) in a positioning group. In a SCI associated with a SL-PRS transmission.

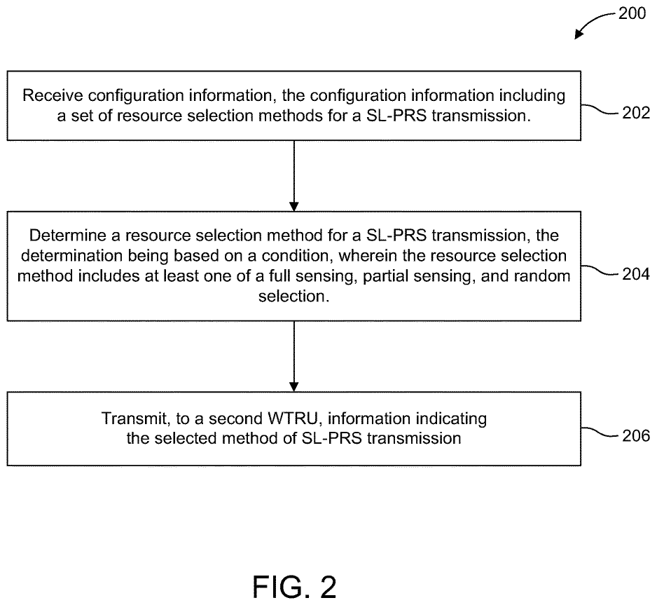

FIG. 2 is a flowchart illustrating an exemplary procedure 200 for a dynamic determination of a resource selection scheme. At 202, a WTRU may receive configuration information, the configuration information including a set of resource selection methods for a sidelink-position reference signal (SL-PRS) transmission. At 204, the WTRU may determine a resource selection method for a SL-PRS transmission, the determination being based on a condition, wherein the resource selection method includes at least one of a full sensing, partial sensing, and random selection. At 206, the WTRU may transmit, to a second WTRU, information indicating the selected method of SL-PRS transmission.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

1. A method performed by a first wireless transmit/receive unit (WTRU), the method comprising:
receiving configuration information, the configuration information including a set of resource selection methods for a sidelink-position reference signal (SL-PRS) transmission;
determining a resource selection method for a SL-PRS transmission, the determination being based on a condition, wherein the resource selection method includes at least one of a full sensing, partial sensing, and random selection; and
transmitting, to a second WTRU, information indicating the selected method of SL-PRS transmission.

2. The method of claim 1, wherein the condition is based on a sidelink-channel busy ratio (SL-CBR) measurement.

3. The method of claim 1, wherein the condition is based on a quality of service (QOS) level indication of the SL-PRS transmission.

4. The method of claim 1, wherein the condition is based on a channel condition.

5. The method of claim 1, wherein the condition is based on an inter-WTRU coordination information.

6. The method of claim 1, wherein the condition is based on a SL-PRS transmission feedback.

7. The method of claim 1, wherein the information indicating the selected method of SL-PRS transmission is transmitted in a sidelink control information (SCI) with the SL-PRS transmission.

8. A first wireless transmit/receive unit (WTRU) comprising:
a transceiver; and
a processor;
wherein the transceiver and processor are configured to:
receive configuration information, the configuration information including a set of resource selection methods for a sidelink-position reference signal (SL-PRS) transmission;
determine a resource selection method for a SL-PRS transmission, the determination being based on a condition, wherein the resource selection method includes at least one of a full sensing, partial sensing, and random selection; and
transmit, to a second WTRU, information indicating the selected method of SL-PRS transmission.

9. The first WTRU of claim 8, wherein the condition is based on a sidelink-channel busy ratio (SL-CBR) measurement.

10. The first WTRU of claim 8, wherein the condition is based on a quality of service (QOS) level indication of the SL-PRS transmission.

11. The first WTRU of claim 8, wherein the condition is based on a channel condition.

12. The first WTRU of claim 8, wherein the condition is based on a an inter-WTRU coordination information.

13. The first WTRU of claim 8, wherein the condition is a SL-PRS transmission feedback.

14. The first WTRU of claim 8, wherein the information indicating the selected method of SL-PRS transmission is transmitted in a sidelink control information (SCI) with the SL-PRS transmission.
